(19) United States
(12) Patent Application Publication
(10) Pub. No.: US 2003/0089019 A1
(43) Pub. Date: May 15, 2003

(54) George's easy hunt description

(76) Inventor: George Allen Napier, Semora, NC (US)

Correspondence Address: George A. Napier, 535 Cunningham Road, Semora, NC, 27343, US

(21) Appl. No.: 09/909,091

(22) Filed: Dec. 11, 2001

Related U.S. Application Data
(60) Provisional application No. 60/268,011, filed on Feb. 12, 2001.

(51) Int. Cl. A01M 1/00

(52) U.S. Cl. 43/1

(57) ABSTRACT

A Mobile Deerstand House which can be set up automatically by use of a 12 volt wench and goes up to 20 feet tall. The deerstand can be moved by a pick-up truck or other vehicle and also can be moved deeper into the woods by a four wheeler that is carried on the trailer under the deerstand. Accomodates 2 people comfortable with hunting gear and chairs for seating.

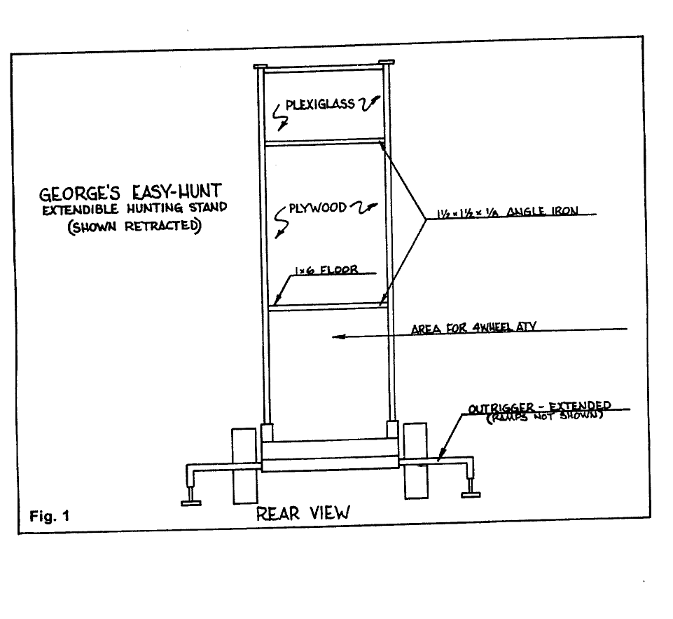

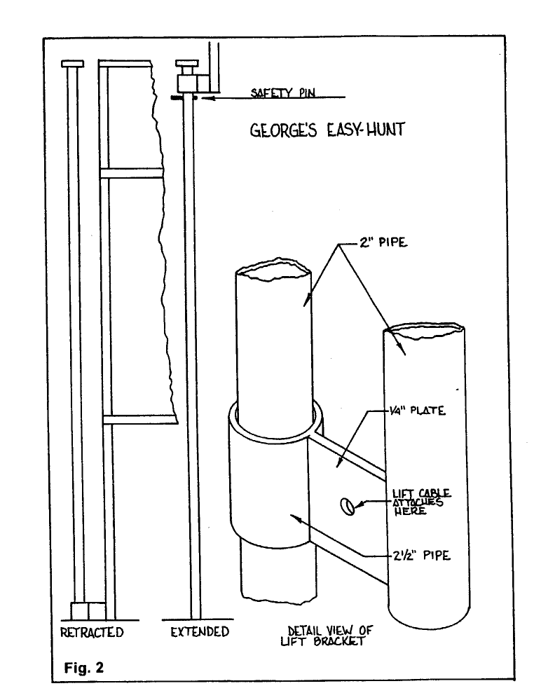

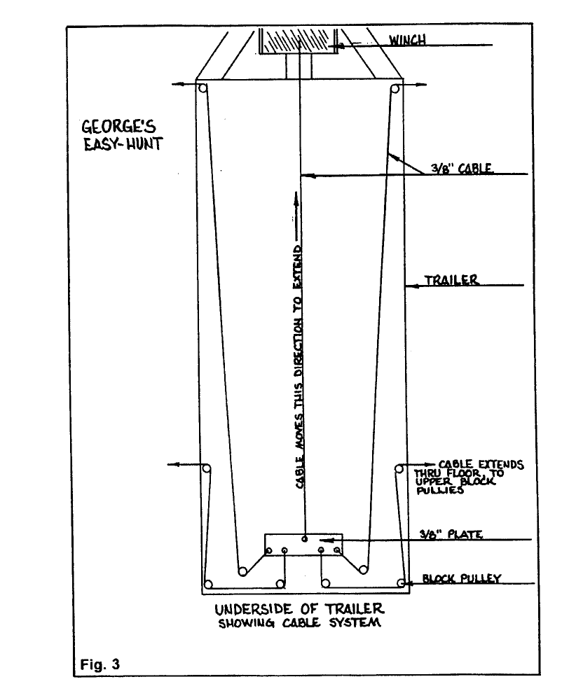

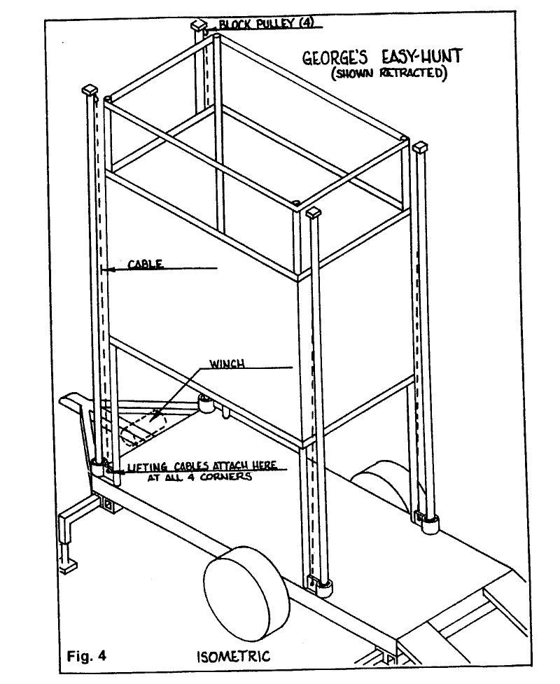

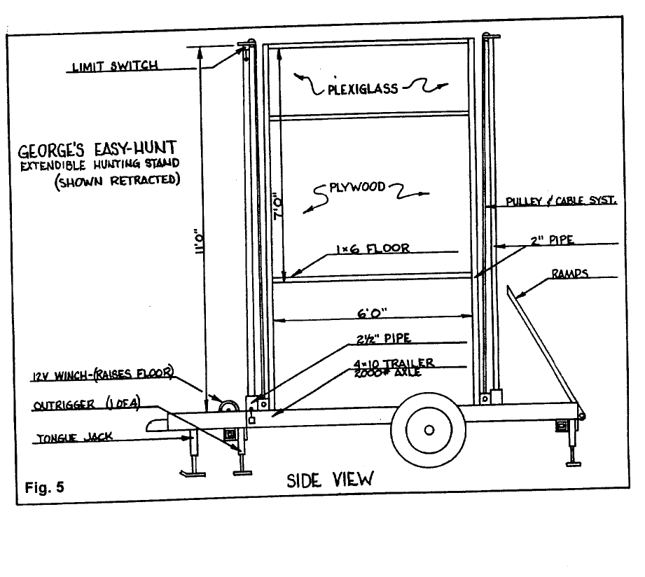

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

### Background of George's Easy Hunt

I have been working on this deer stand in my mind for over two years. As a hunter over 50 years old, without a lot of time to prepare for hunting, not always enough land for a stationary stand, bad weather, and being able to hunt leased or other land without having to build a permanent stand, I developed this idea.

When I have time to hunt, it is either cold or rainy due to the seasons and since I am a construction worker, rigger by trade, I knew I could come up with a solution for this problem. I needed to make a mobile stand that could be carried into rough terrain and cut-overs, large grain fields with little or no damage to the land and set up in ten minutes. By having the four wheeler carried beneath the stand, it can be un-loaded when your truck will no longer travel in the terrain and hooked to the stand to carry it into this rough area. I have not found anything of this kind on the market and firmly believe there is a big market for this for regular and handicapped hunters.

Other uses include motorcycle or car races so you could see once the stand is extended up to 22 feet quickly for a good view while the bottom part is open. This stand will keep you warm and dry since it is can be closed in and is large enough inside to accommodate two people comfortably. I think this will be an easy way for so many working professionals and hunters to enjoy the sport they with limited time. I have built a prototype and it works just great.

### BRIEF SUMMARY OF THE INVENTION

This mobile deerstand house improves the previous deer houses because the previous made houses are mounted on stationary towers and almost impossible to move. This house has the advantages of keeping the hunter warm and dry, is fully mobile, raises from 11 feet in height to 20 feet in height by simply turning a switch, can hunt cutovers, large fields and can be set up in 15 minutes. My deerstand has a top and is closed in by plexiglass for wind protection which keeps it warm and dry. The deerstand is large enough to accommodate 2 people with their equipment and two chairs to make the hunters comfortable. It is very easy to move the deerstand from your hunting site to your home for storage while not in use.

### BRIEF DESCRIPTION OF THE SEVERAL VIEWS OF THE DRAWING

George's Easy Hunt has 5 pages of illustrations attached to this disclosure to show how it is made to work. Following is a description of each page that makes this deer stand different and unique.

Page 2 illustrates how the easy hunt retracts and extends and the method of how the wench, cable and guide on the 2-inch pipe work together.

Page 3 shows how the cables mount to the wench at a central point to raise and lower the deer house.

Page 4 illustrates the cable and the 12 volt wench working together to lower and raise the deer house.

Page 5 shows the deer house ready to travel minus the four wheeler.

The real abstract disclosure is the way the cables and wench work together to raise and lower the deer house as illustrated in drawing pages 3 and 4.

### DETAILED DESCRIPTION OF THE INVENTION

First make the trailer that deer stand is mounted on, which is 4′ by 10′ long with at least a 3 foot tongue, 2½×2½×¼ inch tubing to mount a 3000 pound, 12 volt wench, the trailer is made of 6″ channel carbon steel welded together and has a 2000 lb axle with 14′ rims. It has 4 screw jack stands for setting up the trailer mounted on 2 inch square tubing which is mounted to a 2½ inch tubing welded to the trailer with a threaded bolt welded to a nut which is welded to the channel so when the outrigggers are extended or retracted, they will be secure. All the channel iron must be turned inward which gives room to mount the sheaves for the lifting cable. On all 4 corners, there is a 2 inch pipe, 10 feet long, schedule 40 welded to the trailer corners on the side of the corners with a hole cut in the channel for the cable to run through. Top of the 2 inch pipe there is a 3 inch sheave mounted for the cable to also run through. On the 3 foot tongue, there is a 3000 lb wench mounted. Which must be equipped with its own brake. On the 2 inch pipe, there is a 2½ inch pipe sleeve, 6 inches long on each one of the 4 pipes for a guide only. On the deer house itself, there is four 1 and ½ inch pipe schedule 40, 10 feet long. There is a gusset plate, of 4×4×¼ inch steel, lifting lug welded to the 1½ inch pipe to the 2½ inch pipe sleeve for lifting the deer house in all four corners. There is a cable mounted to all four gussets, each gusset has its own cable. They run up to the top of the 10 feet 2 inch pipe, over the sheave, down through the pipe, through another sheave and this takes several sheaves to run them all through the back of the trailer. There is 4 sheaves mounted to the back of the trailer channel to a central location so that the wench can pull all four of them at the same time. It has 4½×6 inch eye bolts mounted to the ⅜ inch steel cable for adjustment so the deerstand will pick up on a level. The wench has a 3 part cable in it to reduce the speed of raising the deer house. The house is mounted 4 feet up from the trailer welded to the 1½ inch pipe, the pipe now becomes the wall stabilizers for the deer house. It has 2×2×¼ angle welded 4 feet up from the bottom of the trailer and 6 feet up to the 1½ inch pipe, has 4 more 2×2 angle welded to the top of the pipe. This is to mount the top to and also for mounting the sides which are ¼ inch plyboard and plexiglass. The overall height of the deerstand is less than 12 feet tall in it retracted mode. Once you get to your location, you turn the wench on to raise the deerstand. When it is fully raised, there are 4½ inch holes drilled in the ½ inch pipe for safety pins. The safety pins are made of ⅜ inch coldroll steel which has a 2 inch, 90

1. I claim my invention of a mobile deer stand that is unique by the way it is raised in height mounted on a trailer, lifted by use of cables through pipe to a central location, all pulled at the same time regardless of the method from which they are pulled.
The deer stand has four 2-inch pipes, welded square frame of 6-inch channel with a hole in the bottom pipe.
The pipe stands vertical and at the bottom, mounted to the 6 inch channel is a sheave underneath the pipe.
At the top of the same pipe is another sheave.
The deer stand house is made of 1½ inch pipe vertically.
The rest is on 6-inch channel frame for trailer.
The 2-inch pipe has a 6-inch by 2-½ inch pipe sleeve around it and has a 4 by 4 by ¼ inch gusset welded between the sleeve and 1½ inch pipe.
A 4-inch pipe sleeve acts as a guide for 1½ inch pipe.
This is done on all four corners of the trailer.
A cable mounts to 4 by 4 by ¼ inch plate, and it goes up 10 feet.
The 2-inch pipe is 10 feet tall.
The cable goes up through sheave, down inside the 2-inch pipe, through the bottom, and out. This is done in all four corners.
All the cables go to the back of the trailer to another sheave mounted in the corner of the trailer in the back.
There are another four sheaves mounted in the back of the trailer where all four cables come to a central point.
This being to get a 10-foot lift, the trailer has a 3-foot tongue mounted on it with a hole cut in the front channel that the tongue is mounted to on which is mounted a 12-volt wench, 3000 pound line pull.
